(19) United States
(12) Patent Application Publication
(10) Pub. No.: US 2021/0215522 A1
(43) Pub. Date: Jul. 15, 2021

(54) Metering device for temperature-controlled beverages

(71) Applicant: MPS INNOVATION GMBH, Fußach (AT)

(72) Inventors: Stefan SALZGEBER, Hard (AT); Maximilian PRINZ, Lochau (AT); Peter SCHWÄRZLER, Fußach (AT)

(21) Appl. No.: 16/328,339

(22) PCT Filed: Aug. 14, 2017
(86) PCT No.: PCT/EP2017/000977

§ 371 Date: Feb. 26, 2019

(30) Foreign Application Priority Data
Aug. 26, 2016 (DE) 102016010375.2

(51) Int. Cl. G01F 11/32; F16K 11/07; B67D 3/02

(52) U.S. Cl. CPC G01F 11/32; B67D 3/02; F16K 11/07

(57) ABSTRACT

A metering device for the metered withdrawal of free-flowing beverages and sauces from at least one storage container, including at least one chamber having an inlet for receiving the liquid from the storage container and an outlet for dispensing the metered liquid into a vessel, wherein the metering device has at least one temperature control device that heats or cools the metered liquid, wherein the metering device has two chambers that are arranged one above the other and are connected to one another in a fluid-conducting manner by a connecting channel, and wherein a vertically displaceable push rod extends along a longitudinal axis of the housing, through the outlet, the second chamber, the connecting channel, the first chamber, and the inlet, and, depending on the vertical position, the push rod closes the outlet and/or the connecting channel in a fluid-sealing manner and actuates the closure.

### FIELD

The invention relates to a metering device for the metered withdrawal of free-flowing beverages and sauces from at least one storage container.

### BACKGROUND

Metering devices, pourers, or also dosers for beverages are already known from the prior art. These devices are usually apparatuses that require actuation from the outside, and upon each repeated, identical actuation dispense a predefined quantity of a fluid or a free-flowing solid substance from a feed line or a container. Metering devices have the advantage that the beverage mixtures may always be conveniently prepared with the precise, identical composition. A further advantage is that losses during dispensing are avoided.

There are metering devices for upright bottles as well as for bottles that are suspended with the opening facing downwardly (inverted). In the inverted variant, the metering device is initially fastened to the opening. The bottle is subsequently placed into a (wall) mounting, with the opening facing downwardly. The metering device is made up essentially of a housing having a metering chamber, and a vertically movable dispensing closure. To dispense the metered liquid, the glass to be filled is pressed vertically upwardly against a metering valve or lever handle of the closure. The closure opens the metering chamber and releases the preportioned liquid, which flows into the glass situated thereunder.

Utility Model DE 20 118 605 U1 discloses a beverage dispensing device with a bottle, containing a potable liquid, that is mounted upside down on the dispensing unit. The bottle with its neck is inserted into a coupling connection in the dispensing unit, and via line elements is connected to the dispensing tap. A cooling or heating device with which the beverage may be cooled or heated to the particular temperature is situated in the area of the dispensing unit.

Utility Model DE 20 2007 012 732 U discloses an adapter device for connecting beverage cans or bottles, wherein the can is mounted on the device in an upside down position. According to paragraph [0045], the dispensing unit may be equipped with an additional heating device for heating the liquid.

The embodiments according to the prior art have the disadvantage that heating of the liquid takes place solely while the liquid is flowing (continuous flow heater principle). It is not possible to precisely control the final temperature, since the heating range is dependent on the flow rate and the heating power, but the heating power, despite a variable starting temperature, is not adapted. Thus, for extremely cold ambient temperatures this is not adequate for heating the metered beverages to the desired final temperature. In particular in ski areas and snow bars therein, there is a need for serving the customers with a metered hot beverage.

In addition, in the prior art it is not possible to quickly dispense multiple metered hot beverages with precise metering into glasses within a short period of time.

### SUMMARY

The object of the invention, therefore, is to provide a metering device that dispenses a precisely metered and temperature-controlled liquid into vessels, multiple times and in rapid succession, even with greatly varying starting temperatures.

To achieve the stated object, the invention is characterized in that the metering device along its longitudinal axis has at least two different heatable and/or coolable metering chambers that are connected to one another via a valve mechanism. During dispensing of the liquid, the inlet and outlet openings of the two chambers are opened or closed by a shared, vertically displaceable push rod.

The stated technical teaching results in the significant advantage that a metered liquid having the desired, uniform temperature may be dispensed multiple times in succession from the metering device according to the invention. This has not been possible thus far with the metering devices according to the prior art, since the liquid was heated solely in the area of the dispensing opening, which is unsatisfactory at low ambient temperatures, for example. In addition, the prior art provided only a continuous flow cooler, so that a uniform temperature could not be ensured during rapid dispensing in succession.

In a first preferred embodiment, the metering device is made up of a housing, having a total of two chambers arranged one above the other. The first chamber is situated in the upper area of the housing, and has a coupling unit for accommodating an adapter with a valve, into which a bottle containing a potable liquid is insertable upside down. The bottle with its neck is preferably screwed or plugged into the adapter, and the bottle together with the adapter is then inserted into the coupling unit of the first chamber, thus ensuring a secure hold.

The liquid flows from the bottle into a first chamber. The volume of the first chamber is designed for receiving, for example, 80 mL of a liquid. The first chamber is thus used as a first metering chamber and has a temperature-controllable design, i.e., is heatable and/or coolable. It is thus possible for the first time to heat or cool the liquid, coming from the storage container situated thereabove, to a first temperature without controlling the temperature of the remaining liquid present in the original container, since thermal decoupling is present.

In one preferred embodiment, the potable liquid in the first chamber is heated to 55° to 75°, for example. A second chamber, which is connected to an internal valve mechanism via a vertical connecting channel, is situated below the first (metering) chamber.

The second (metering) chamber is preferably smaller than the first chamber, and has a volume for receiving, for example, approximately 20 mL of a potable liquid. The volume of the second chamber thus corresponds to the desired metered volume that is to be dispensed to the drinking vessel situated thereunder.

At the lower end, the second chamber has an opening that is preferably closed by the push rod of the valve mechanism. If the push rod is now pushed upwardly in the vertical direction, the lower opening of the second chamber is thus opened up and the metered liquid may flow unhindered from the second chamber into the vessel situated thereunder (a drinking glass, for example).

However, before the lower opening of the second chamber is opened, the push rod during the upward vertical movement closes the connecting channel between the second and first chambers. In particular, unhindered running out of the liquid from the first chamber into the second chamber is thus avoided. Furthermore, as a result, during the tapping operation no further liquid subsequently flows into the second chamber and through the released opening into the drinking glass. Thus, during the tapping operation only the metered quantity of liquid in the second chamber flows into the drinking vessel.

When the push rod of the valve mechanism is released, the outlet is closed in the direction of the drinking glass, and the connection between the first chamber and the second chamber is reopened, as the result of which the quantity to be dispensed is once again premetered.

In the metering device according to the invention, it is critical that a sufficient quantity of the temperature-controlled liquid is always available by the use of two temperature-controllable (metering) chambers. This is achieved in particular in that the first, larger chamber controls the temperature of the liquid from the storage container beforehand, and the second, smaller chamber thus has to compensate for only a small temperature difference.

The present invention is not limited to the withdrawal of a liquid from a bottle. The liquid may also be withdrawn from a canister or a tank. It is also possible for the coupling unit or the adapter of the first chamber to be connected only to a hose, with the liquid being supplied from a (remote) tank to the metering device. Furthermore, use of a pump or a pressurized gas container that cooperates with a suitable pressure reducer is also possible.

Of course, the metering device according to the invention may also be used as a tapping unit, dispensing unit, or beverage dispensing unit. It is important that the device heats or cools various beverages from storage containers, such as bottles, barrels (often kegs), tanks, or so-called bags-in-box (BIBs), to a desired temperature and fills them into drinking vessels.

All free-flowing substances may be metered with the metering device which is essential to the invention. Thus, for example, metering of alcoholic and nonalcoholic beverages, mustard, ketchup, mayonnaise, sweet sauces such as raspberry sauce or vanilla sauce, and salty sauces, in particular for salads or the like, is possible.

In another embodiment, the metering device is used in the field of massage therapy for heating and metered dispensing of massage oil.

The housing of the metering device according to the invention is preferably made of metal, for example stainless steel, copper, or aluminum, which has a very high degree of purity. However, for the chamber body of the housing, other materials such as plastics, fiber-reinforced plastic, or the like are possible. A highly thermally conductive material is generally preferred so that the liquids, starting from the temperature control device, may be easily and quickly heated.

There is also the option for the housing to be made of a different material than the (metering) chambers. Thus, for example, the housing may be made of a plastic, while the chambers are manufactured from an insert made of stainless steel or glass, for example. In general, the present invention makes claim to all materials for all components used.

All equipment for heating liquids with the aid of electrical energy, as well as heat transfer medium that is temperature-controlled externally, may be used as a heating device for the metering device. In this regard, not only the overall housing, but also individual subareas such as individual chambers may have a heatable design. The two chambers arranged one above the other preferably have two different heating elements. As a result, liquid in the first chamber may for example have a lower temperature than the liquid in the second chamber.

Of course, in addition to the heating device, the metering device according to the invention may also have a cooling device via which the liquids in the first and second chambers may be cooled to the desired temperature. Cooling of the entire housing is also possible. A cooling compressor, for example, may be used to cool the individual liquids within the metering device. In addition, a continuous flow cooler is also possible.

Use of the metering device according to the invention outdoors is particularly meaningful, since temperatures of −5° may be present, but a customer would like to have a plum liqueur at a temperature of 30°. In snow bars, the bartender must therefore be able to prepare a certain number of beverages having a uniform temperature, within a relatively short period of time. Due to the preheated quantity of liquid in the first chamber (80 mL, for example), for example up to 20 liqueur drinks, each containing 20 mL and having a uniform temperature, may be dispensed from the second chamber in a very short time.

Thus, the subject matter of the present invention results not only from the subject matter of the individual patent claims, but also from the combination of the individual patent claims with one another.

All information and features disclosed in the application documents, including the abstract, in particular the spatial design illustrated in the drawings, are claimed as essential to the invention, provided that, alone or in combination, they are novel with respect to the prior art.

The invention is explained in greater detail below with reference to drawings that illustrate multiple implementation approaches. In this regard, further features and advantages of the invention that are essential to the invention emerge from the drawings and their description.

### BRIEF DESCRIPTION OF THE DRAWINGS

In the drawings:

FIG. 1: shows a schematic partial section of the metering device according to the invention.

FIG. 2: shows a side view of the metering device.

FIG. 3: shows a schematic illustration of the metering device.

FIG. 4: shows a perspective illustration of the metering device.

FIG. 5: shows a perspective illustration of the housing.

FIG. 6: shows a side view of the metering device without lift.

FIG. 7: shows a side view of the metering device with lift.

FIG. 8: shows a section A-A of the metering device with lift shown in FIG. 7.

FIG. 9: shows an illustration of the push rod according to the invention in a first embodiment.

FIG. 10: shows an illustration of the push rod according to the invention in a second embodiment.

### DETAILED DESCRIPTION

FIG. 1 shows in a general manner that the metering device 1 is made up essentially of a housing 2 with at least two (metering) chambers 8, 9. The housing 2 has an upper part 3 in the top area. The upper part 3 is preferably detachably connected to the housing 2, and preferably has a cylindrical coupling unit, within which an adapter 4 for the storage container 26 is situated.

The adapter 4 is exchangeable, and is used as a fixing device for the storage container 26. For example, a bottle in the inverted position may be held with its neck or its body in the metering device 1 with the aid of the adapter 4. However, the adapter 4 may also be designed in such a way that it holds a hose or canister that supplies the first chamber 8 with the desired liquid via the inlet 15.

As stated above in the general description section, the metering device 1 according to the invention may withdraw a liquid from different storage containers 26. The exchangeable adapter 4 thus establishes a fluid-tight connection between the storage container 26 and the housing 2 or the inlet 15 of the housing 2. Also situated in the region of the inlet 15 is a closure 7 that closes the inlet 15 with respect to the storage container 26. The closure 7 is preferably actuated by the push rod 5.

The closure 7 is situated in a coupling unit 6 that is detachably mounted with respect to the housing 2. The detachable coupling unit 6 allows, among other things, removal of the closure 7 for cleaning and maintenance operations, and in addition, different types of closures 7 may thus be inserted into the same housing 2. The closure 7 is generally designed in such a way that it drops into its closed position due to the force of gravity or a spring or the fluid pressure of the storage container 26 when the push rod 5 is retracted. When the push rod 5 is pushed upwardly in the vertical direction, the closure 7 opens and releases the inlet 15 for the liquid in the storage container 26.

When the closure 7 is open, starting from the storage container 26 the liquid flows through the inlet 15 and into the first chamber 8. The first chamber 8 is designed in such a way that it can preferably hold a liquid volume of approximately 80 mL. However, the invention is not limited thereto. Rather, the chambers 8 and 9 may have any volume.

A second (metering) chamber 9 that is connected to the first chamber 8 via a connecting channel 12 is situated below the first (metering) chamber 8. The second chamber 9 is preferably smaller than the first chamber 8, and has, for example, a volume for receiving 20 mL of liquid. On the bottom side the second chamber 9 has an outlet 19 through which the liquid in the second chamber 9 exits.

A push rod 5 extends along a vertical axis, through the housing 2, in particular through the outlet 19, the second chamber 9, the connecting channel 12, the first chamber 8, and the inlet 15. The push rod 5 is vertically displaceable within the housing 2, and has different diameters along its longitudinal axis, so that when the push rod 5 is displaced in the arrow direction 16, the opening 18 within the push rod 5 is opened up, the connecting channel 12 is closed, and at the same time the closure 7 is opened.

In the region of the second chamber 9, the push rod 5 has a portion 24 with an increased diameter, so that the push rod rests on the outlet 19 in a sealing manner. When the push rod 5 is displaced in the arrow direction 16, the portion 14 is moved in the vertical direction, so that a portion 25 having a smaller diameter opens up the opening 18.

In the region of the portion 25, the push rod 5 preferably has a borehole that is designed as an opening 18 for the liquid from the second chamber 9.

The metered liquid, starting from the second chamber 9, may preferably be dispensed to the glass situated thereunder in two ways:
The push rod 5 has an opening 18 designed as an internal T-shaped borehole. In the closed state of the metering device, the opening 18 of the push rod 5 is closed by the walls of the outlet 19, so that no liquids can escape. When the push rod 5 is displaced vertically upwardly, the T-shaped opening is brought into the region of the chamber 9, as the result of which the liquid may flow out of the chamber through the opening 18.
The push rod 5 in the region of the outlet 19 is designed in such a way that when the push rod is displaced vertically upwardly, the outlet 19 is opened up and the liquid flows out of the chamber 9 through the outlet 19.

By use of the metering device 1 according to the invention, it is thus possible for the first time to dispense a metered quantity of liquid to a drinking vessel 21 from the second chamber 9 through the outlet 19 or the opening 18, while at the same time a liquid, starting from the storage container 26, subsequently flows into the first chamber 8.

It is also apparent, with reference to FIG. 1, that the housing 2 has a vent 10 for the second chamber 9 which is designed as a separate channel.

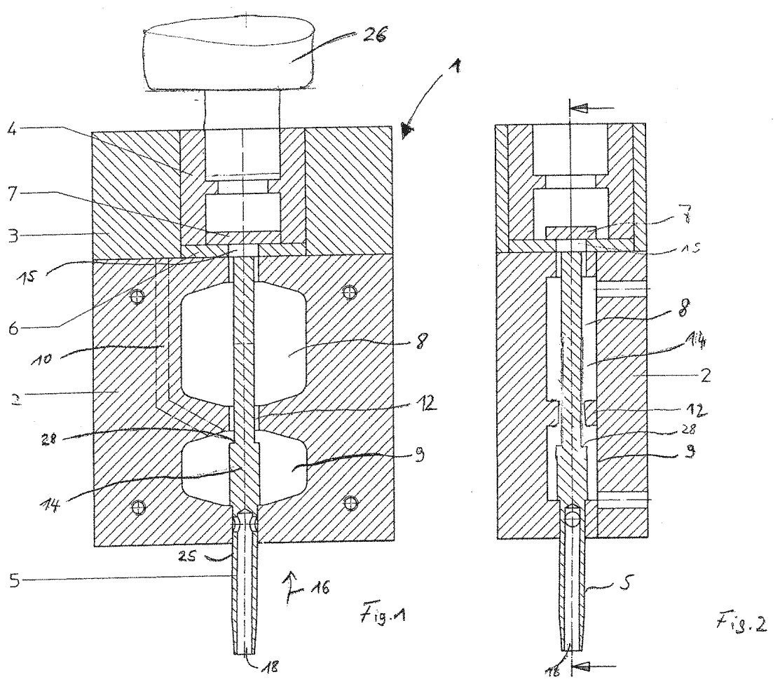

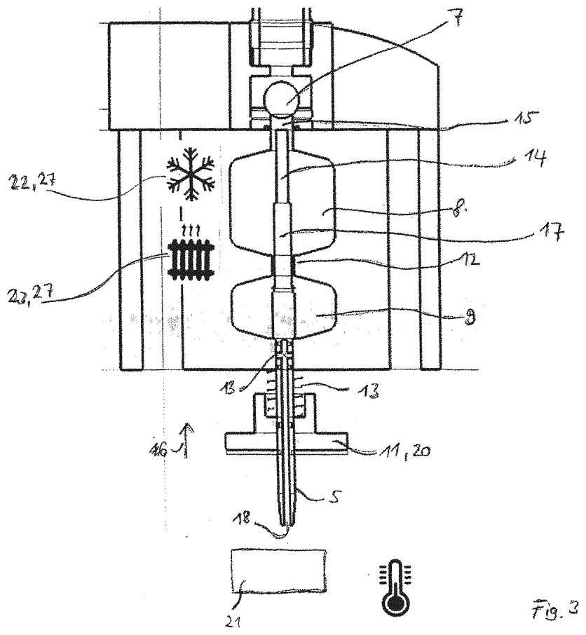

FIG. 2 illustrates the metering device 1 in a lateral section. The closure 7 rests on the inlet 15, and thus closes the first chamber 8 with respect to the liquid in the storage container 26.

The push rod 5 is in the starting situation. According to the present invention, the starting situation is understood to mean that the closure 7 is closed, the connecting channel 12 is open, and the opening 19 is closed.

According to FIG. 3, the housing 2 of the metering device 1 has at least one temperature control device 27 for liquids, which is made up of at least one cooling device 22 and/or one heating device 23. The liquids in the chambers 8, 9 may be either cooled or heated with the aid of the temperature control device 27.

Each chamber 8, 9 preferably has its own temperature control device 27, so that, for example, the liquid in the first chamber 8 is heated to a temperature of approximately 30° C. Preheating of the liquid in the storage container 26 for the second chamber 9 thus takes place in the first chamber 8. This has the significant advantage that the second chamber 9 now always has a sufficient quantity of preheated liquid.

By use of the embodiment according to the invention, numerous different temperature control variants with regard to the liquids in the first and second chambers 8, 9 are possible, for example:
the first and second chambers 8, 9 have the same temperature or
The first chamber 8 has a higher temperature than the second chamber 9 or
the first chamber 8 has a lower temperature than the second chamber 9
the first chamber 8 has a higher temperature than the temperature of the storage container 26, and has a lower temperature than the temperature of the second chamber 9.

The above-mentioned variants are only examples. The present invention makes claim to all temperature variants.

The push rod 5 has a metering valve 11 in the region of the outlet 19. The metering valve 11 is situated elastically with respect to the housing 2 by means of a spring assembly 13. The drinking vessel 21 is preferably pressed downwardly with its edges against the metering valve 11, as the result of which the push rod 5 is pushed vertically upwardly, and the outlet 19 dispenses the liquid from the second chamber 9 to the drinking vessel 21.

In addition to the metering valve 11, other dispensing valves 20 are possible for the metering device 1. The closure 7 according to FIG. 3 is designed as a ball valve.

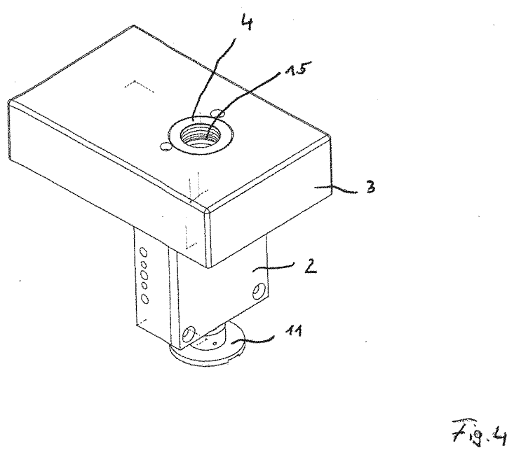

FIG. 4 shows a perspective view of the metering device 1, which is made up essentially of the housing 2 and the upper part 3. The metering valve 11, which is connected to the push rod 5, is situated in the lower area.

The upper part 3 has a recess within which the round adapter 4 for the storage container 26 is situated. The inlet 15 is situated below the adapter 4.

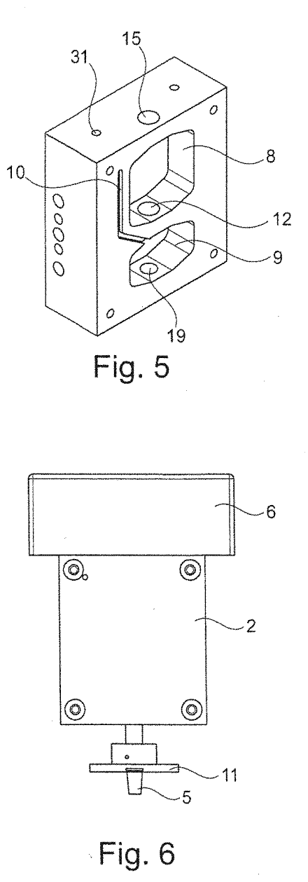

FIG. 5 shows the housing 2 of the metering device 1. The housing 2 essentially has two chambers 8, 9, arranged one above the other, which are connected to one another in a fluid-conducting manner by a connecting channel 12. The inlet 15, the first chamber 8, the connecting channel 12, the second chamber 9, and the outlet 19 are all situated on an axis. It is thus possible for the push rod 5 to be situated so that it is vertically displaceable in the housing 2, and upon vertical actuation, opens the second chamber, closes the connecting channel 12, and opens the inlet 15.

Situated on the end-face side of the metering device 1 is at least one borehole 31, which extends through the metering device 1 in the vertical direction and into which at least one heating element of the heating device 23 or one cooling element of the cooling device 22 is insertable. Depending on the requirements, multiple boreholes may be present in order to increase the heating or cooling power. Alternatively, a heating or cooling plate may be flange-mounted on the housing body.

Of course, it is also possible for the metering device 1 to have horizontal boreholes 31 which, for example, extend in front of or behind the chambers 8, 9. It is critical that the boreholes 31 are situated relatively close to the region of the chambers 8, 9 in order to achieve rapid, effective heating or cooling of the liquid.

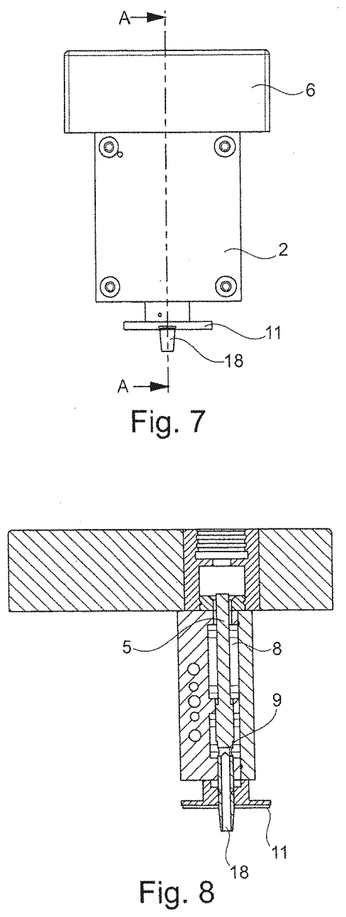

FIG. 6 shows the metering device 1, in the side view without lift. FIG. 7 shows the metering device 1 with lift, the metering valve 11 having been moved vertically upwardly.

FIG. 8 shows the section A-A through the metering device 1 according to FIG. 7. As an example, it is shown that the push rod 5 undergoes vertical displacement, i.e., carries out a lift of 11 mm, within the housing 2.

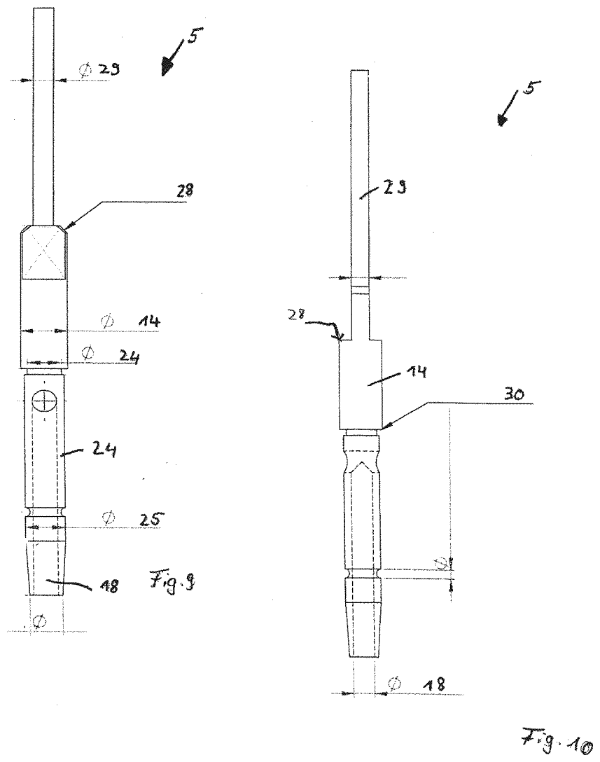

FIGS. 9 and 10 show the push rod 5, which is essential to the invention, in a top view and side view, respectively.

In the starting state, the push rod 5 with its wider portion 14 and its sealing surface 30 rests on the outlet 19 of the second chamber 9, and seals it with respect to the housing 2. When the push rod 5 moves vertically, the sealing surface 30 is lifted from the outlet 19, as the result of which the metered quantity of liquid flows from the second chamber 9, through the opening 18, and into the drinking vessel 21.

The length of the wider portion 14 is selected in such a way that upon a vertical movement of the push rod 5, the outlet 19 is opened, and shortly before, the connecting channel 18 together with the sealing surface 28 of the portion 14 is closed.

The push rod 5 according to FIG. 9 has a first portion 29. The diameter of the portion 29 is smaller than the diameter of the portion 14 situated thereunder. In the installed state of the push rod 5, the portion 29 extends through the first chamber 8 and the inlet 15. The length of the portion 29 of the push rod 5 is selected in such a way that, due to the vertical displacement of the push rod 5 with a lift of 11 mm, for example, at the same time the closure 7 is lifted and the liquid flows from the storage container 26 into the first chamber 8.

Upon a vertical upward displacement of the push rod 5, the wider portion 14 with its sealing surface 28 also rests downwardly against the connecting channel 12 of the second chamber 9 and seals it with respect to the liquid in the chamber 8 and thus, also with respect to the storage container 26.

FIG. 10 shows a rotated embodiment from FIG. 9, wherein the push rod 5 in the portion 14 has only sharp-edged sealing surfaces 28, 30, resulting in a seal with respect to the connecting channel 12 and the outlet 19.

In the metering device according to the invention, it is critical that with only one vertical movement of the push rod 5, the second chamber 9 is opened and the connection between the first and second chambers is closed. At the same time, the closure 7 is opened, so that new liquid can flow from a storage container 26 into the first chamber 8.

The metering device 1 according to the invention thus has the advantage that a first quantity of liquid is heated or cooled to a certain temperature with a temperature control device, so that the second chamber 9 already has a sufficient quantity of liquid at the desired temperature. As a result, a metered liquid having the desired temperature may be dispensed from the metering device at brief intervals.

The metering device 1 is not limited to two chambers 8, 9 arranged one above the other. Of course, for example three or more chambers may also be arranged one above the other.

It is critical that when the push rod 5 is actuated, due to its geometry it opens or closes all inlet and outlet openings with only one lift movement. The push rod 5 thus has a type of valve function, which in a fluid-sealing manner opens or closes the outlet 19 of the second chamber 9 and/or the connecting channel 12, as well as the closure 7.

### LIST OF REFERENCE NUMERALS

1 metering device
2 housing
3 upper part
4 adapter
5 push rod
6 coupling unit
7 closure
8 first chamber
9 second chamber
10 vent
11 metering valve
12 connecting channel
13 spring assembly
14 portion of 5
15 inlet
16 arrow direction (top)
17 expansion
18 opening
19 outlet
20 dispensing valve
21 drinking vessel
22 cooling device
23 heating device
24 portion (first chamber)
25 portion (opening 19)
26 storage container
27 temperature control device
28 sealing surface (top)
29 portion
30 sealing surface (bottom)
31 boreholes for the cooling or heating device 22, 23

1. A metering device (1) for the metered withdrawal of free-flowing beverages and sauces from at least one storage container (26), made up of at least one chamber (8, 9) having an inlet (15) for receiving the liquid from the storage container (26) and an outlet (19) for dispensing the metered liquid into a vessel (21), wherein the metering device (1) has at least two chambers (8, 9) that are arranged one above the other, and are connected to one another in a fluid-conducting manner by a connecting channel (12), and a vertically displaceable push rod (5) extends through the outlet (19), the second chamber (9), the connecting channel (12), the first chamber (8), and the inlet (15), and, depending on the vertical position, the push rod (5) closes the outlet (19) and/or the connecting channel (12), characterized in that the metering device (1) is made up of a one-part, block-like housing (2) that contains the at least two chambers (8, 9), and the metering device (1) has at least one temperature control device (22, 23, 27) that heats or cools the metered liquid.

2. The metering device (1) according to claim 1, characterized in that the push rod (5) has a one-part design, and has a portion (14) with a larger diameter and at least two sealing surfaces (28, 30) that rest against the outlet (19) of the second chamber (9) and/or the connecting channel (12) in a fluid-sealing manner.

3. The metering device (1) according to claim 1, characterized in that the metering device (1) has an exchangeable adapter (4) that establishes a fluid-conducting connection between different storage containers (26) and the inlet (15).

4. The metering device (1) according to claim 1, characterized in that the metering device (1) in the region of the inlet (15) has a movable closure (7) that is actuatable by the push rod (5).

5. The metering device (1) according to claim 1, characterized in that the first chamber (8) is larger than the second chamber (9).

6. The metering device (1) according to claim 1, characterized in that each chamber (8, 9) has its own temperature control device (22, 23, 27).

7. The metering device (1) according to claim 1, characterized in that the chambers (8, 9) have a shared temperature control device (22, 23, 27).

8. The metering device (1) according to claim 1, characterized in that the push rod (5) in the region of the outlet (19) is coupleable to a dispensing valve (20).

9. The metering device (1) according to claim 1, characterized in that the push rod (5) in the region of the outlet (19) has a metering valve (11) that is supported in the vertical direction with respect to the bottom side of the housing (2) by means of a spring assembly (13).

10. The metering device (1) according to claim 1, characterized in that the metering device (1) is made of stainless steel.

11. The metering device (1) according to claim 1, characterized in that the metering device (1) is made of aluminum.

12. The metering device (1) according to claim 1, characterized in that the adapter (4) is situated within an upper part (3) that is detachably connected to the housing (2).

13. The metering device (1) according to claim 1, characterized in that the entire housing (2) has a heatable or coolable design.

14. The metering device (1) according to claim 1, characterized in that the housing (2) is made of a highly thermally conductive material.
